(19) United States
(12) Patent Application Publication
(10) Pub. No.: US 2015/0367268 A1
(43) Pub. Date: Dec. 24, 2015

(54) FILTRATION MEDIUM

(71) Applicant: DUSTEE PTY LTD AS TRUSTEE FOR THE DUSTEE UNIT TRUST, New South Wales (AU)

(72) Inventors: Damian Joseph Cullen, New South Wales (AU); Jurg Schutz, Belmont, Victoria (AU)

(21) Appl. No.: 14/766,381

(22) PCT Filed: Feb. 3, 2014
(86) PCT No.: PCT/AU2014/000072

§ 371 Date: Aug. 6, 2015

(30) Foreign Application Priority Data
Feb. 6, 2013 (AU) 2013900374

(51) Int. Cl. B01D 39/08; D01G 13/00; D04H 1/46; B01D 46/00

(52) U.S. Cl. CPC B01D 39/083; B01D 46/0001; B01D 46/0032; B01D 46/0057; D01G 13/00; D04H 1/46

(57) ABSTRACT

The present invention provides a particulate filtration medium comprising a combination of a wool fibre obtained from an animal, and a synthetic polymeric fibre, the wool fibre being coated with a water soluble resin, wherein the medium is capable of reclaiming electrostatic charge after a washing and/or drying procedure.

### RELATED APPLICATIONS

This application claims the benefit of Australian provisional patent application 2013900374, filed on 6 Feb. 2013, the specification of that application being incorporated herein by reference.

### FIELD OF THE INVENTION

The present invention relates to media for filtration of airborne particles. While the media is particularly useful in respiratory filtration masks, other uses are contemplated.

### BACKGROUND TO THE INVENTION

All inhaled particulates are considered harmful to some degree. Included among particularly harmful particulates are silica, asbestos, sugar cane fibre, carborundum, diatomite, talc and cotton particulate—each of which can result in lung damage when particulate control is inadequate.

The most common harmful particulate in mines is that which contains silica, the deleterious health effects increasing proportionally with the percentage of silica in the particulate, and inversely proportion to particulate size. More harmful particulates are those less than 5 microns in size, that is, particles smaller than 0.005 mm.

In the building construction industry, airborne particulates are problematic, especially during building demolition and renovation. Particulates such as concrete dust and asbestos fibres cause significant occupational health and safety concerns given the repeated exposure by some workers.

Various personal respiratory masks adapted to cover the mouth and nose have been used over the years to prevent workers from inhaling airborne particulates in the course of their vocation. Respiratory masks may also be used by the general population to prevent inhalation of pathogens and exhaust particulates in everyday life. While generally effective, the use of such masks can give rise to a number of problems, a significant one being the general inconvenience of carrying and handling.

The invention described in the international patent application published as WO2010/003182 (to HINCHEY and CULLEN) addressed the difficulties associated with the use of personal respiratory masks in the work place. This document provided a solution in the coupling of a mask element anchored to the collar of a work shirt. Other approaches are disclosed in U.S. Pat. No. 7,228,858 (to BAKER), U.S. Pat. No. 6,418,559 (to WRECSICS et al) and U.S. Pat. No. 5,713,077 (to HUMBRECHT).

While the incorporation of filtration means into clothing provides undoubted advantages, a further problem is created in that the laundering of the garment has been found to result in a significant diminution of filtration efficiency. Thus, while garment-associated filtration means are more likely to be used by individuals due to increased convenience, the filters are less likely to be effective in removing airborne particulates.

A problem that is not particular to garment-associated filtration means is the clogging and general loss of performance that occurs over time. While it is tempting to simply wash the mask to remove residues this often leads to a severe diminution of performance, leaving the user exposed to the inhalation of dangerous particulates.

It is an aspect of the present invention to overcome a problem of the prior art by providing a filtration medium that is capable of retaining filtration performance after washing and drying.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect the present invention provides a particulate filtration medium comprising a combination of a wool fibre obtained from an animal, and a synthetic polymeric fibre, the wool fibre being coated with a water soluble resin, wherein the medium fibre is capable of reclaiming electrostatic charge after a washing and/or drying procedure.

In one embodiment the water soluble resin forms a substantially continuous coating on the wool fibre. In one embodiment the water soluble resin is not a brittle or frangible resin. In one embodiment the water soluble resin is not a natural resin.

In one embodiment the water soluble resin consists of, or comprises, a polyamide. In one embodiment the water soluble resin consists of, or comprises, a polyamide-epichlorohydrin resin. In one embodiment the water soluble resin consists of, or comprises a cationic polyamide-epichlorohydrin resin. In one embodiment the water soluble resin consists of, or comprises Herocosett 125 or Hercosett 57.

In one embodiment prior to the application of the resin, the wool fibre is treated to increase the surface energy of the cuticle. In one embodiment prior to the application of the resin the wool fibre is contacted with an oxidant. In one embodiment the oxidant is chlorine.

In one embodiment the animal is of the Caprinae family. In one embodiment the animal is of the Ovis genus.

In one embodiment the washing and/or drying procedure is a domestic laundering procedure, optionally followed by a domestic tumble drying procedure.

In one embodiment the synthetic polymeric fibre is a polyolefin. In one embodiment the polyolefin is polypropylene. In one embodiment the medium is a nonwoven medium.

In one embodiment the washing and/or drying procedure is a domestic washing and/or drying procedure.

In a second aspect the present invention provides a method for producing a particulate filtration medium, the method comprising the steps of providing a wool fibre having a characteristic as described herein, combining the wool with a polymer fibre, and optionally forming the combined fibres into a felt.

In one embodiment before use the felt is washed a first time and dried, and optionally washed a second time and dried such that softener present on the fibre is removed.

In one embodiment the felt is needled.

In a third aspect the present invention provides a method for fabricating a particulate filter, the method comprising the steps of providing a particulate filtration medium as described herein and packing the medium into a filter housing.

In one embodiment the filter housing is, or is part of a mask suitable for locating over the mouth and/or nose.

In one embodiment the mask is incorporated into or associated with a garment.

### BRIEF DESCRIPTION OF THE FIGURES

FIG. 1 shows photographs of marked filtration media at different stages of washing: A) Markings on the Needle Punched fabric (PB06) before washing and B) after one wash/tumble dry cycle. C) Marking of circles on the fabric after one treatment cycle and D) new square markings applied before subsequent treatment cycles. E) Fabric after 5 treatment cycles; dimensional changes are illustrated by a new circular marking in red. Arrows with label “MD” mark the main fibre direction.

FIG. 2 shows ATR spectrum of fibres from the wool sliver “as is” (A) and after scouring (B). (C) shows the difference between (A) and (B).

FIG. 3 shows ATR spectra of residues left on the detector crystal originating from fibres of the wool sliver “as is” (A) and after scouring (B).

FIG. 4 shows spectra of DCM extracted residues from fibres of the wool sliver “as is” (A) and after scouring (C). A reference spectrum of POE is shown as trace (B).

FIG. 5 shows results from spectral subtraction of Alcopol 650 from isolated residues originating from fibres of the wool sliver after scouring. Comparison to spectra of known chemical compounds (Tubingal HSI shown).

FIG. 6 shows particle counter results from filter test groups (generally 5 individual measurements).

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects may apply only to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Throughout the description and the claims of this specification the term “consisting of” and variations of the term, such as “consists of” is intended to be construed exhaustively to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part of Applicant's finding that a wool fibre coated with resin can be can be utilised as a component of a filtration medium. It has been unexpectedly discovered that the electrostatic charge of the wool fibres is regenerated after washing and/or drying such that filtration performance is retained. Accordingly, in a first aspect, the present invention provides a particulate filtration medium comprising a combination of a wool fibre obtained from an animal, and a synthetic polymeric fibre, the wool fibre being coated with a water-soluble resin, wherein the medium is capable of reclaiming electrostatic charge after a washing and/or drying procedure.

It has been found that a filtration medium having these features is particularly (although not exclusively) applicable to respiratory filters associated with a garment or a reusable standalone mask. As an example, reference is made to WO2010/003182, the contents of which is herein incorporated by reference. The medium has been shown to provide low penetration to fine particles, and is still highly breathable. Unexpectedly, the medium regenerates significant levels of electrostatic charge after washing and drying.

Advantageously, the filtration medium exhibits resistance to dimensional changes and/or shrinkage in addition to the ability to reclaim electrostatic charge after washing and/or drying. It is unexpected for an electrostatic filtration medium to exhibit high performance levels in respect of these properties simultaneously. Many fabric treatment processes and fibre coatings commonly used in the treatment of wool disrupt the ability of the fibre to retain an electrostatic charge, thereby rendering the wool fibres essentially inutile as a filter medium.

Applicant's discovery provides for the first time a filtration medium comprising a coated wool fibre that is that is capable of retaining shape and charge after a regular domestic washing and drying.

As used herein, the term “wool fibre” is intended to mean any fibre (whether used directly from the animal or twisted into a yarn or textile fibre) that is elastic and obtained from an animal such as a sheep.

In the context of the present invention, the term “reclaiming” with respect to the electrostatic charge of the fibre is intended to mean that an electrostatic charge on the fibre prior to a washing and/or drying procedure is present after that procedure. The term is not intended to be construed narrowly to mean that the level of charge, or the polarity of charge, or the distribution of charge, or any other charge-related characteristic is unchanged. While it is contemplated that there may be an increase or decrease or other alteration in the electrostatic charge, the medium nevertheless retains the ability to function as a filter.

Where reference is made to an “electrostatic charge”, the intention is not to mean a permanent electrostatic charge. Typically, the electrostatic charge is a “quasi-permanent” charge of the kind associated with electrets.

In one embodiment, the filtration medium is a “tribo-electric” medium, where electrostatic charge is separated by some process and deposited by polarity onto two different types of materials, are of interest in this regard because a separation of charge can occur without electrical means, simply by an application of mechanical friction or during evaporation of a liquid from fibre surfaces.

In one embodiment, the water soluble resin is not comprised of resinous particles and instead forms a substantially continuous later on the wool fibre. Less preferred embodiments comprise the use of brittle or frangible resins, including natural resins such as colophony, copal gum, and calcium resinate. Prior patents such as GB1466587 describe the use of brittle resins which, during manufacture of the filtration medium, are broken up into smaller particles by mechanical means to create an electrical charge. By contrast, the manufacture of media of the present invention does not require breaking of the resin to provide charge. The substantially continuous layer of resin on the surface of the fibre leads to advantages in maintaining dimensional stability and avoiding shrinkage.

In one embodiment of the particulate filtration medium, the water soluble resin consists of, or comprises a polyamide. Polyamide resins are high-molecular-weight polymers which feature amide linkages along the molecular chain.

In one embodiment of the particulate filtration medium the water soluble resin consists of, or comprises, a polyamide-epichlorohydrin resin.

In one embodiment of the particulate filtration medium the water soluble resin consists of, or comprises a cationic polyamide-epichlorohydrin resin. Such resins are made by reaction of a dicarboxylic acid with a polyalkylene polyamine under conditions giving a water-soluble polyamide containing the group:

—NH—(CₙH₂ₙHN)ₓ—CO.R.CO—

Wherein n, x are 2 or more, and R is the radical of the dicarboxylic acid. The polyamide is then allowed to react with epichlorhydrin so that all the secondary amino groups are converted into tertiary amino groups.

In one embodiment of the particulate filtration medium the water soluble resin consists of, or comprises one of the Hercosett range of molecules (Hercules Chemical Company), and in particular Hercosett™ 125 or structural or functional equivalent thereof, and/or Hercosett™ 57 or structural or functional equivalent thereof. The resin may consist of, or comprise, one of the Listrilan™ range of compounds (Stephensen group Limited)

In one embodiment the resin comprises both a polymer comprising the protected thiol and an amine or amide-epichlorohydrin resin having one or more azetidinium functional groups.

These are proposed to be amine or amide-epichlorohydrin resin having one or more azetidinium functional groups. Kenores™ polymers may also be suitable resins.

In order to vary the adhesion of the water soluble resin to the wool fibre various pre-treatments of the wool fibre may be effected. In one embodiment the treatment to confer shrinkage resistance comprises the step of increasing the surface energy of the cuticle of the wool. This may be achieved by any chemical and/or physical method known by a skilled artisan. The pre-treatment may comprise contacting the wool fibre with an oxidant such as a halogen. In particular chlorine has been found to be useful.

Methods of coating wool fibres with water soluble resins are known in the art. As a pre-treatment step, some processes uses chlorine gas generated in situ from sodium hypochlorite and sulphuric acid or chlorine gas dissolved in water. The treatment is surface specific because the reaction with the cuticle takes place in less than 10 seconds. The chlorination increases the surface energy of the cuticle so that the resin subsequently applied can spread evenly along the fibre surface. The process may be carried out in a modified backwasher.

The basic chlorine/Hercosett process is familiar to the skilled artisan in the field of textiles, but not to those skilled in the art of filtration media. In one embodiment, the method of coating the wool fibre is achieved by the chlorine/Hercosett process, or equivalent thereof. This process comprises the following operations applied sequentially to sliver or tops:

The first stage involves chlorination, usually with a solution of sodium hypochlorite, at a temperature of 15-20 degrees C. and at a pH of 1.5-2.0. The oxidizing properties of hypochlorite solutions are pH dependent with chlorine, hypochlorous acid and hypochlorite ions existing in equilibrium at a given pH value. A dilute solution of sodium hypochlorite for example, contains essentially the hypochlorous ion OCL- above pH 8.5 and mainly undissociated hypochlorous acid, HOCl at pH 4.5, while at pH 2, free chlorine accounts for approximately 70% of the total active chlorine.

Under the conditions employed in the chlorine/Hercosett process, the bath contains mainly free chlorine and hypochlorous acid, both of which are capable of reacting with the wool. There is claimed to be a considerable difference, however, between the results obtained by treatment with chlorine and with hypochlorous acid.

Both agents impart shrink resistance and produce the effects required of a pre-treatment for subsequent application of a resin but whereas chlorine may be damaging, hypochlorous acid, on the other hand, is believed to cause only slight surface modification and to leave the scale structure of treated fibres almost intact.

Under the conditions employed in the first bowl, chlorination occurs preferentially at the surface of the fibre and in such a way that damage and yellowing are minimized almost completely. The pretreatment may be level across the width and along the length of the web of wool as well as being uniform through the cross-section of individual slivers. A parallel presentation of 30-40 slivers (each weighing 20-30 g/m) to the chlorinating liquor is important to ensure uniformity of treatment.

The most common procedure for chlorinating in this way is to use a Fleissner suction drum backwasher bowl, in which the liquor is drawn from the bowl, through the web of wool and then out at the ends of the perforated drum, back into the bowl. The liquor consists of dilute sulphuric acid, sodium hypochlorite and an acid-stable wetting agent. Quantities of each are pumped continuously into the bowl to provide the correct level of chlorination appropriate to the processing speed and the quality of the wool being treated. Levels of chlorination of between about 1.5% and 2.5% are typical.

During the treatment, the interaction between sulphuric acid and sodium hypochlorite results in an accumulation of various degradation products and soluble salts in the bowl. These include sodium chloride, sodium sulphate, hydrolysed protein and oils which, in time, can reduce the efficiency of the chlorinating reactants. To counteract this, the contents of the bowl are either changed routinely (say every 2 hours) or a controlled, additional supply of water is metered into the bowl to effect constant replenishment of the liquor during processing.

The small amount of chlorine gas which accumulates at the surface of the liquor is corrosive, and high-chrome stainless steel is most suitably used in the construction of the bowl. Excess gas is removed routinely by means of a suction hood situated over the first few bowls or by using a system which aspirates the gas directly above the chlorinating liquor.

The two most popular chlorine donating compounds used for shrink-resist treating wool are sodium hypochlorite and certain alkali metal salts of dichloroisocyanuric acid (DCCA). In use these are mixed with acids and wetting agents in, or prior to entering, the pad nip. Until recently it has been difficult however to prepare stable, concentrated solutions of DCCA at low pH values owing to the precipitation, below pH 3.5, of cyanuric acid and cyanurates. A technique developed by SAWRTI utilizes a mixture of a mineral acid and an organic acid such as acetic acid, to stabilize concentrated, low pH solutions of DCCA. These solutions are stable at pH 1.5-2.5 for a period long enough to allow the continuous chlorination of wool to be carried out in a pad mangle.

After chlorination, the residual acid and chlorine is deactivated by rinsing (optional depending on the availability of a bowl), followed by neutralization and antichlorination. This treatment is effected in a bowl usually containing sodium carbonate and sodium sulphite or metabisulphite. When the chlorination reaction is followed by either a bisulphite or a thioglycollate antichlorination treatment, the absorption of resin is increased substantially. It is also suggested that the affinity of the resin for the pretreated wool is greatest when sodium bisulphate is employed.

In practice sodium sulphite, sodium bisulphate or a mixture of both are the most popular antichlorinating agents used commercially. Since sodium bisulphate is converted to sodium sulphite under the alkaline conditions employed for neutralization of the acid, there is probably little to be gained from using bisulphate which is, generally, more expensive. It is desirable that the temperature of the chlorination liquour should be maintained at approximately 25-30 degrees C. The pH in this bowl is kept at a value of 8.5-9.5, most conveniently with automatic pH control equipment.

Rinsing after neutralization is performed to prevent the accumulation of sulphite in the resin bath where it retards the rate, and therefore the extent, of the exhaustion of the resin on to pretreated wool. The effect of sulphite contamination of the resin bowl on treated wool properties such as shrink-resistance and dyeing behaviour is described elsewhere. The flow of water into the rinse bowl depends on the production rate and is likely to be 500-1,000 litres/hr. Sulphite analysis by titration confirms whether this is adequate. A continuous rinse is ensured by supplying the water via a flowmeter and a solenoid valve connected electrically to the machine drive. In this way, rinsing will occur all the time the backwasher is running. The processes of chlorination, neutralization plus antichlorination and rinsing may together be called the “pre-treatment”, preceding the application of the resin. Without wishing to be limited by theory, it is thought that pretreatment serves various purposes:
(i) To create charged sites on the surface of each fibre to which oppositely charged resin molecules are attracted, and with which they may become covalently bonded.
(ii) To raise the surface tension of the surface of each fibre to a value higher than that of the resin and thus facilitate spreading of the resin during treatment and drying.
(iii) To provide a low level of shrink-resistance which is enhanced considerably by the subsequent application of the resin.

The resin is applied preferably in a suction drum bowl to ensure uniform application through the cross-section of the slivers. A cationic polyamide epichlorhydrin resin, most usually Hercosett 57, (Hercules Chemical Company) is used. The bowl contains this resin and sodium bicarbonate and is maintained at a constant temperature in the range 35-40 degrees C. It is undesirable to allow the temperature to fall below 30 degrees C. or the exhaustion rate of the resin becomes impaired. During processing, resin is supplied to the bowl at the rate of 2% resin solids on the weight of wool by an accurate metering pump. The pH of the bath is maintained at 7.5-8.0 by the addition of sodium carbonate solution, via pH control equipment. Incomplete treatment with the resin, attributable to poor control of the parameters outlined above, is manifested by inferior staining tests (q.v.), inadequate shrink-resistance, hard tops and dyeing difficulties.

The wool is then passed into the last bowl in which a softener is typically applied. As discussed elsewhere herein, softeners may impair the generation or retention of an electrostatic charge on the fibre. In these circumstances, the softener step is not carried out. Where the treated wool fibre is obtained form a third party, various washing procedures may be utilized to remove the softener.

A high temperature cure during the drying step completes the process.

Modifications to the basic process include the Kroy Deepim™ Process, which proven advantageous for medium quality wool fibres. The process may be carried out by recently developed continuous chlorination equipment namely System 2™ from Fleissner and 3G™ chlorination from Andar.

In some circumstances the resin-coated wool fibre may also have an antistatic compound incorporated which is preferably removed. The removal may be achieved by vigorous washing. Alternatively the process by which the resin is coated onto the fibre is devoid of the step of exposing the fibre to a softener.

In one embodiment of the particulate filtration medium the animal from which the wool is obtained is of the Bovidae family, subfamily Caprinae. This subfamily includes the genera Nemorhaedus, Rupicapra, Oreamnos, Budorcas, Ovibos, Hemitragus, Ammotragus, Pseudois, Capra, and Ovis.

For practicality and/or convenience, the animal is preferably of the Ovis genus, which comprises the species Ovis ammon, Ovis aries aries, Ovis aries musimon, Ovis vignei, Ovis canadensis, Ovis dalli, and Ovis nivicola.

For reasons of practicality and/or convenience, the animal is preferably Ovis aries aries (the common sheep).

Media of the present invention may be tested both before and after washing to establish to ability to substantially reclaim filtration performance. A number of experimental methods for measuring particulate filtration performance are known in the art, with one strategy being disclosed herein in the description of the preferred embodiment. Various analyses may be undertaken to quantitatively define filtration performance, in addition to those explicitly described herein. It is therefore to be understood that filtration performance may be established using methods other than those described herein with a view to demonstrating the reclamation of electrostatic charge, and therefore the ability to retain airborne particulates.

In one embodiment, the filtration performance before washing as compared with after washing is greater than about 40, 50, 60, 70, 80, or 90% for fine particles in the 0.3-0.5 μm particle size range when utilising the performance measurement method described herein. Preferably, the performance is at least about 75% for fine particles in the 0.3-0.5 μm particle size range when utilising the performance measurement method described herein. More preferably, the performance is at least about 80% for fine particles in the 0.3-0.5 μm particle size range when utilising the performance measurement method described herein. This 80% performance satisfies the requirements for a P1 performance rating (Committee SF/10 Inparticulaterial Respiratory Protection, AS/NZS 1716:1994 Respiratory Protective Devices, 1994, Standards Australia).

In one embodiment of the particulate filter the washing and/or drying procedure is a domestic laundering procedure, optionally followed by a domestic tumble drying procedure. In one embodiment, the washing process is carried out at a water temperature of at least about 20, 25, 30, 35, 40, 45, 50, 55, 60, 65 or 70 degrees Celsius.

In one embodiment, the washing process is carried out in the presence of a domestic laundry detergent. Exemplary detergents comprise one or more of the following: a detergent/surfactant (such as an alkylbenzenesulfonate), a builder (such as sodium carbonate), a bleach (such as sodium perborate), and an enzyme (such as an amylase or a protease).

In one embodiment, the washing process is carried out in a domestic washing machine, and the drying in a domestic tumble dryer.

In one embodiment, the washing and drying procedures are as described In ISO 6330:2000/AMD.1:2008(E) Textiles—Domestic Washing And Drying Procedures For Textile Testing, 2008, International Organization For Standardization (ISO).

In addition to the resin-coated coated wool fibre, the present medium contains a synthetic polymeric fibre. The role of this second fibre is to carry the opposite charge to the wool component, which is in most cases the negative charge.

In one embodiment, the synthetic polymer has an electrical resistance which is significantly higher than that of the resin-coated wool fibre. Preferably the resistance of the synthetic polymer is very high, and may have a resistance of greater than 10-fold, 100-fold, 1000-fold, 10000-fold, or 100000 fold that of the resin-coated wool fibre.

Suitably, the synthetic polymer is a polyolefin (also known as a polyalkene) in some embodiments of the filtration medium. The polyolefin may be produced from a simple alkene monomer such as ethylene, propylene, butylene, pentylene or hexylene. Modified polyolefins may also be used in some embodiments, such as polymethylene and polybutene-1.

The ratio of wool fibre to synthetic polymer fibre may be chosen according to any desired characteristic of the resultant filtration medium. Blends of about 40% synthetic polymer to about 60% wool have been shown to be effective. However blends having polypropylene content of greater than about 5%, 10%, 15%, 20%, 25%, 30%, 35%, 40%, 45%, 50%, 55%, 60%, 65%, 70%, 75%, 80%, 85%, 90% and 95% (with the balance being wool) may be effective for certain applications.

In one embodiment of the medium, the medium is devoid of a third fibre type having an active role in particulate filtration.

Typically, the particulate filtration medium is a nonwoven medium. Apart from any technical advantages the nonwoven form has economical advantages in production of the filtration medium. Typically, the nonwoven material is a felt made by either a wet felting process or a dry (or needle) felting process. The processes are well known to the skilled partisan and for the sake of brevity and clarity will not be more fully described.

It will be understood by the skilled artisan that the medium may be electrostatically charged (or recharged) by the evaporation of a non-polar solvent (such as water, which occurs in wet felting), needling, or other mechanical stress placed on the medium.

One aspect of the present invention is to provide a garment-associated respiratory filter that may be laundered without substantial alteration to the shape or dimensions of the medium, or to the filtration efficiency. Accordingly, in one embodiment of the particulate filtration medium as described herein the washing and/or drying procedure is a domestic washing and/or drying procedure.

In a further aspect, the present invention provides a method for producing a particulate filtration medium, the method comprising the steps of providing a wool fibre having a characteristic as described herein, combining the wool with a polymer fibre, and forming the combined fibres into a nonwoven structure, such as a felt.

The medium may be washed a first time and dried, and optionally washed a second time and dried. These washing and drying steps may have the effect of (i) providing an initial electrostatic charge and/or (ii) removing softeners or antistatic agents on the wool fibre which could interfere with the electrostatic charge.

In one embodiment of the method, the medium is needled. This may have the effect of (i) increasing the physical strength of the medium and/or (ii) providing an initial electrostatic charge.

In another embodiment, the method comprising the steps of providing a particulate filtration medium as described herein, and packing the medium into a filter housing.

In one embodiment the filter housing is, or is part of a mask element suitable for locating over the mouth and/or nose. The mask may be incorporated into or associated with a garment.

In another aspect the present invention provides an article of protective clothing including a garment for covering at least an upper portion of the body of a wearer; the garment including: a mask element coupled to the garment wherein the mask element can adopt a stowed position, and a deployed position in which the mask element extends forward to cover the nose and/or mouth of the wearer, wherein the mask element comprises a filtration medium as described herein.

In one embodiment of the article of protective clothing, the mask element may adopt a stowed position in which at least a portion of the mask is disposed underneath a portion of the garment. In one form, the mask element is in the form of a bight, concave or closed loop. The mask element may be coupled to, and extend from at least one anchor region on the garment.

According to another embodiment of the article of protective clothing, the garment includes a shirt type folded collar including an over fold wherein the mask in the stowed position is disposed underneath the over fold. In one form of this embodiment, the at least one anchor region is/are located on part of the folded type collar and may be located on an under surface of the over fold of the shirt type folded collar. In one embodiment, the mask element is coupled to, and extends from two anchor regions wherein the two anchor regions are located on opposite sides of the shirt type folded collar proximate the to the middle of the respective sides of the wearer's neck.

According to an alternative embodiment the garment includes a pocket portion located proximate a neck region of the garment wherein the mask in the stowed position is disposed within the pocket portion. In one form of this embodiment, the pocket portion is located on a back side of the garment wherein the at least one anchor region is/are located within the pocket portion

In one embodiment, the mask element is detachably coupled to the garment, in another embodiment the mask element is detachably coupled to the garment by hook and loop fasteners.

In one embodiment the mask element acts as a filter. In another form, the mask element acts as a filter for particulate matter and/or airborne diseases. In one form the mask element is substantially hidden from view in the stowed position.

The present invention further provides a method of portably inhibiting ingestion of dust and/or airborne pollution, the method including the steps of: providing an article of protective clothing including a garment for covering at least an upper portion of the body of a wearer; the garment including: a mask element coupled to the garment wherein the mask element can adopt a stowed position, and a deployed position in which the mask element extends forward to cover the nose and/or mouth of the wearer; and, deploying the mask element to cover the mouth and nose of the wearer, wherein the mask element comprises a filtration medium as described herein.

According to another aspect the present invention provides a mask element adapted to be attached either permanently or removably to a garment for covering at least an upper portion of the body of a wearer, the mask element being configured to adopt a stowed position, and a deployed position in which the mask element extends forward to cover the nose and/or mouth of the wearer, wherein the mask element comprises a filtration medium as described herein.

While the filtration media of the present invention are useful in the context of a personal respiratory filter, other uses are contemplated. The ability to recharge a filter by washing and drying (a process which will also remove gross contaminants) affords advantage in other settings such as air handling systems, air conditioners and the like.

The present invention will be now more fully described by reference to the following non limiting examples.

### EXAMPLES

### Example 1

### Manufacture of the Filtration Medium

Properties of Fibre Stock

| | | Surface | Blend | Quantity |
|---|---|---|---|---|
| Fibre Type | Properties | weighted Ø | Ratio | Required |
| Hercosett | 21.1 μm, Hercosett treated (sliver) | 18.3 μm | 56.7% | 401 |
| treated Wool | | | | grams |
| Polypropylene | 3 denier (21.6 μm), 65 mm long, | 19.7 μm | 43.3% | 150 |
| | hydrophilic spin finish removed by | | (by wt.) | grams |
| | scouring | | | |
| | 3 denier (23.6 μm), 55-65 mm long, | 20.6 μm | | 157 |
| | no spin finish | | | grams |

Antistatic fabric softener was washed off from the Hercosett wool prior to processing of the nonwoven web. Polypropylene was free of anti-static agent.

Washing of Wool Sliver

Process 3 kg of sliver in the 5-bowl treatment line:

| | |
|---|---|
| Bowl 1: | 1 g/L Alcopol 650 in 50° C. water; |
| Bowls 2-5: | 50° C. water only. |

Processing Specifications:

| | |
|---|---|
| Dwell time in each bowl: | approx. 20 seconds |
| Processing speed: | 8 m/min (nominal) |
| Number of slivers processed in parallel: | 2 |
| Sliver weight: | 20 g/m |

Fibres were subsequently dried in two passes through a dryer.

Nonwoven Manufacture

Fibre Web: Blend 40% polypropylene with 60% Hercosett wool by weight for processing on Memmingen Card:
Processing Weight: approx. 700 g (total PP=307 g; Wool=401 g), prepare 2 batches.
2 passes per web; blend on conveyor; fold in two after first pass.
Place 2 webs on top of each other for needle punching.

Nonwoven Fabric: Consolidate web on Dilo needle punch:
Needle Boards (Dilo): 1 full board (3″, 40 gauge needles), 1 blank board.
Process Parameters: Processing parameter sheet from 18 Apr. 2012 (see below): Needle density: 55 pp/cm²; stroke rate: 225; 2 passes, change sides between passes.

### Example 2

### Washing and Tumble Drying

Preparation:

Shrinkage Test: Marking of three 14.9 cm by 14.9 cm areas with centre point on the nonwoven fabrics prior to treatment.

Washing according to ISO 6330-2000/Amd1.2008(E) [15]:

Subject a 0.5 m×1.0 m piece of the nonwoven fabric to:
2A normal 60° C. wash cycle in Wascator with makeweights, followed by
Kenmore tumble drying, Normal/Perm Press, more dry

Measure the dimension of the 14.9 cm×14.9 cm markings on the dry fabrics to determine dimensional changes.

### Example 3

### Filter Testing

Evaluate filtration performance on the PCFTI:
Number of sample (replicates) per medium: 3
Carded Webs: perform PCFTI tests on No 1 samples
   for the first time shortly after needle punching
   for a second time together with the washed fabrics, at least 3 days after needle punching.
Washed Fabrics: conduct tests together with second test of carded webs

A nonwoven needle felt was manufactured from clean wool and polypropylene fibre stock, which involved the removal of processing agents from fibre surfaces by washing, followed by a drying cycle

The cleaned and dried fibres were subsequently blended at a ratio of 56.7 wt. % Hercosett wool to 43.3 wt. % polypropylene that had been optimised for a large electrostatic particulate holding capacity and processed to a web on a nonwoven card.

The mechanical strength of the loose web was increased by consolidating fibres into a more dense felt by means of needle punching.

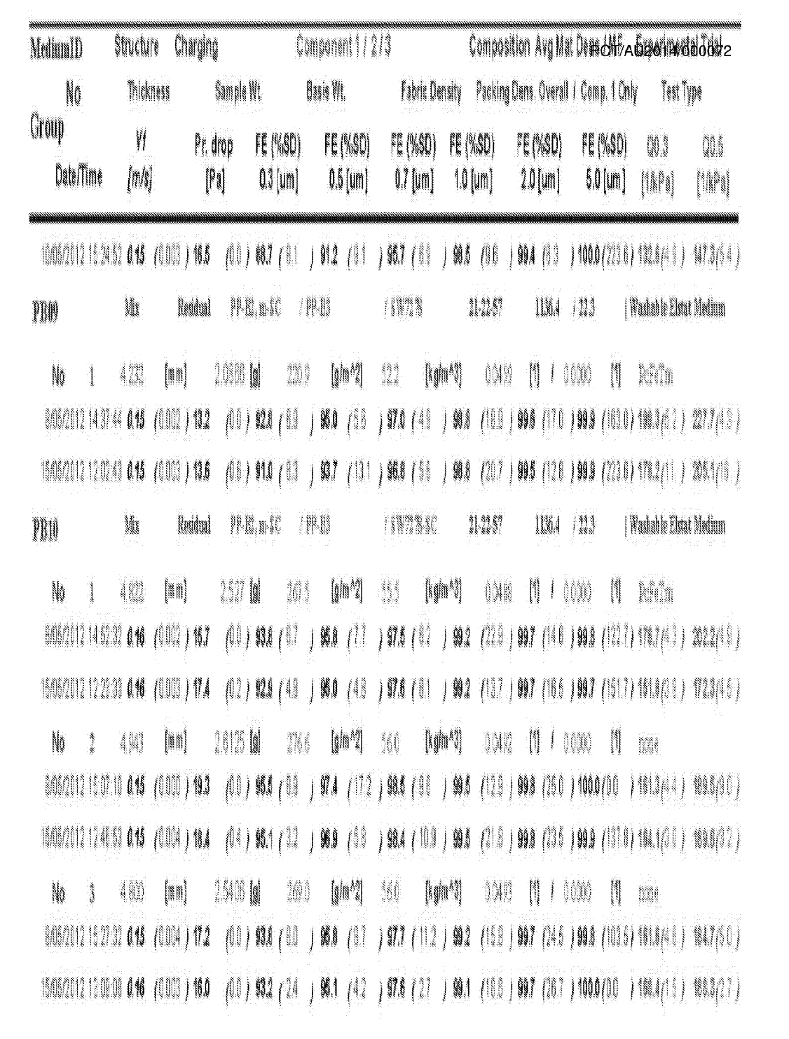

After the first wash, the filtration performance was measured (see FIG. 6, medium PB02), showing a significant shortfall from the desired performance of 80%. Analysis demonstrated that the filtration performance remained stable.

The consolidated nonwoven fabric was washed as a whole for a second time using the wool scouring detergent that had been used for the first cleaning process.

After the second wash, the fabric was found to have a filtration performance of 70%-75% efficiency (see FIG. 6, medium PB06).

The useable width of the fabric is approximately 90 cm, which is slightly smaller than the 1 metre processing width of the Memmingen card used for web formation. The Dilo needle punch has a processing width of 2 metres, which allowed the fabric to be processed unchanged. The length of the fabric was limited by the 4.7 metre circumference of the collector drum of the Memmingen card to a useable length of approximately 4.5 metres.

### Example 4

### Measurement of Performance

Filtration Test Method

The filtration test involved subjecting a test sample to a challenge of potassium chloride particles from an atomiser. The filtration efficiency was calculated from particle concentrations measured upstream and downstream of the filter sample by means of two optical particle sizers. The TSI 9306 particle sizers provide particle counts size resolved in six fractions of 0.3 to 0.5 μm, 0.5 to 0.7 μm, 0.7 to 1.0 μm, 1.0 to 2.0 pm, 2.0 to 5.0 μm and >5.0 μm.

The pressure differential across the filter sample that built up by the air flow through the medium was measured by an electronic pressure sensor. This pressure differential is termed “pressure drop”.

Performance Benchmark: Quality Factor

Since filtration efficiency and pressure drop are both affected by properties such as fabric thickness or fabric density, it is generally useful to calculate the metric termed “quality factor” as follows:

$$Q = \frac{- ln ( P )}{Δ p} \qquad ( 1 )$$

In this equation P denotes the penetration, which is equal to (1−FE/100) with FE denoting filtration efficiency in percent, In( ) the natural logarithm and Δp the pressure drop. This metric allows comparisons to be made between different media in terms of the quality of the filtration medium (e.g. evenness) and strongly suppress the influence of thickness, fabric weight or packing density.

A modified definition of the quality factor is used that accounts for the influence of face velocity vf:

Qx=Q·v_{f}·η (2)

The dynamic viscosity η is introduced because this extension is based on Darcy's Law.

A brief discussion of filter test results is provided in the following. Reference is made to FIG. 6 for the complete set of averages and standard deviations from measured data groups, where a group is made up of 5 individual measurements.

Filtration Test Reports

FIG. 6 provides data on mechanical properties of a medium and of its filtration performance. Blue/green for information on the media, burgundy for sample properties and black/red for filter test results.

Each measurement contains information on date and time when the measurement was taken, face velocity in metres per second, filtration efficiencies for the six size bins (“FE (% SD) 0.3 [μm]” to FE (% SD) 5.0 [μm]” in percent), the pressure drop in Pascal, the quality factor Q for the smallest two size bins (e.g. “Q0.3 [1/kPa]” for the 0.3-0.5 μm size bin).

The quality factor Q for purely mechanical filter media without electrostatic charge has an upper ceiling value of approximately 20 kPa−1 for the 0.3 μm to 0.5 μm particle size bin (Q0.3) if measured with this particular instrument (PCFTI). It is fairly independent of fibre diameter (ranging from 100 nm to 50 μm) and packing density (within 3% to 20%) and provides therefore a general benchmark for filtration performance. Deviations of the quality factor Q from the ceiling value, if measured at a fixed face velocity, are due to compromises in evenness (accounting for a lower value) or the presence of electrostatic charge (leading to an increase).

Summary of Filtration Test Results

Filtration tests were conducted on the Particle Counter Filter Test Instrument (PCFTI) at different stages of processing. In order to have a negative control (representing the worst case with no electrostatic performance) to benchmark the effect of electrostatic action, a second filter sample was made in the same way as the nonwoven reference medium, but using wool fibres “as is” that were still coated with the anti-static softener. Results from these tests are summarised in Table 1 and include results from the negative control.

TABLE 1
Results from PCFTI filter tests conducted at different stages of processing

| | Pr. | | FE | | FE | | FE | | FE | | FE | | FE | | Q | |
|---|---|---|---|---|---|---|---|---|---|---|---|---|---|---|---|---|
| | Drop | | 0.3 | | 0.5 | | 0.7 | | 1.0 | | 2.0 | | 5.0 | | 0.3 | |
| | (Pa) | SD | (%) | SD | (%) | SD | (%) | SD | (%) | SD | (%) | SD | (%) | SD | (kPa⁻¹) | SD |
| Negative | 14.0 | 1.4 | 7.2 | 1.7 | 5.2 | 2.9 | 12.1 | 0.7 | 18.0 | 2.4 | 22.7 | 0.8 | 32.0 | 3.5 | 5.9 | 2.0 |
| control | | | | | | | | | | | | | | | | |
| Non-woven | 16.0 | 2.0 | 56.5 | 4.6 | 56.4 | 5.9 | 67.1 | 5.1 | 78.9 | 4.7 | 86.2 | 4.0 | 92.2 | 2.6 | 52.6 | 3.5 |
| m'facture | | | | | | | | | | | | | | | | |
| Needle | 17.1 | 1.4 | 70.8 | 4.1 | 72.7 | 4.5 | 82.3 | 1.6 | 90.7 | 0.9 | 95.2 | 0.4 | 97.8 | 0.3 | 72.7 | 3.0 |
| punching | | | | | | | | | | | | | | | | |
| 1 | 15.7 | 0.9 | 87.9 | 1.6 | 90.6 | 1.4 | 95.2 | 1.0 | 98.2 | 0.6 | 99.3 | 0.2 | 99.8 | 0.2 | 134.8 | 3.0 |
| Wash/dry | | | | | | | | | | | | | | | | |
| cycle | | | | | | | | | | | | | | | | |
| 5 | 17.3 | 1.2 | 93.7 | 1.2 | 95.7 | 1.1 | 97.9 | 0.5 | 99.3 | 0.2 | 99.7 | 0.1 | 99.9 | 0.2 | 161.4 | 8.6 |
| Wash/dry | | | | | | | | | | | | | | | | |
| cycles | | | | | | | | | | | | | | | | |

The value of “Q0.3”, which is the value of the quality factor Q for the 0.3 μm-0.5 μm particle size, can be used to represent how a positive control (i.e. a medium with best-practice electrostatic performance) would perform. As discussed above in Section 3.2.1, this benchmark takes on a value of 20 kPa−1 if the web structure is uniform and not charged. However, if high levels of electrostatic charge are present, this value can be one order of magnitude higher. This means that the quality factor target value of a positive control would be in the vicinity of Q0.3≈200 kPa−1.

Results from Table 1 illustrate how the filtration efficiency increases with each treatment step and how the quality factor Q0.3 follows in line. The pressure drop (column “Pr. drop”), however, remains fairly constant. Even though the starting point for the wash trial (Section 3.3.1) was the fabric labelled “Needle punching”, results indicate that the filtration performance of the fabric was getting better with each “Wash/dry” cycle, which illustrates the effectiveness of the re-charging process by rigorous tumble drying. This is likely because the additional washing removed more of the anti-static spin finishes, which further improved its electrostatic properties. The value of Q0.3 (161 kPa−1) after 5 Wash/dry cycles is very close to the benchmark set by the positive control. The filtration efficiency therefore exceeds the target value of >80%.

The overall filtration performance of the filtration medium therefore fulfils the specifications set for the trial. Further details are provided in Appendix D of this report.

Dimensional Stability and Shrinkage

Dimensional changes of the fabric after washing and tumble drying were monitored for the purpose of evaluating the effectiveness of the chlorine Hercosett (Cl/Herc) shrink-proofing treatment. Another indicator is the change in fabric basis weight or aerial density (usually expressed in grams per square metre or gsm).

Since nonwoven fabrics have comparably poor dimensional stability in comparison to woven fabrics, it is necessary to distinguish between dimensional changes due to fabric structure and those caused by shrinkage as a result of the “ratchet-effect” from wool scales. These two factors are not clearly separable, which will require that the suitability of a fabric is judged according to the specific purpose for which it is used.

The assessment of fabric shrinkage was affected in this trial by the difficulties that were encountered with the removal of an anti-static softener from the Cl/Herc treated wool. Additional wash cycles, the use of a relatively strong detergent, and tumble drying should not affect the performance of the shrink-proofing of the wool, but were nevertheless not ideal in terms of establishing the full potential of the wool-polypropylene filtration medium. It is, however, possible to overcome these issues by selecting Cl/Herc treated wool with a spin finish that is easy to remove by means of scouring.

The same issue was solved successfully for the polypropylene by sourcing a fibre stock with hydrophilic spin finish that could be cleaned effectively by means of scouring in hot water.

The actual experiment on dimensional stability and shrinkage was conducted only after additional cleaning treatments had led to an acceptable filtration performance of the filter fabric. The conditions under which the wash and tumble dry cycles were conducted and results obtained from the resulting fabrics are discussed below.

### Example 5

### Laundering the Filtration Medium

The process of washing and tumble drying of the filter fabric is described in ISO Standard 6330 for general textiles. Within this standard, fabrics were subjected together with makeweights to a 2A wash cycle followed by tumble drying according to Procedure E. The equipment was an Electrolux “Wascator” washing machine and a Kenmore tumble dryer.

A 0.9 m by 0.4 m section of the starting fabric (PB06) was subjected to a single 2A wash/tumble drying cycle and assessed for filtration performance (PB08) and dimensional changes. One quarter of the fabric was retained, while the remaining three quarters were subjected to another four wash/tumble dry cycles. The fabric subjected to a total of 5 wash/tumble dry cycles (PB10) was subsequently analysed in the same way. Resulting changes in measured fabric properties are summarised in Table 2, while dimensional changes are discussed in Section 3.3.2.

It is possible to gain insight into fabric shrinkage from changes to the basis weight of a fabric. Table 2 lists the basis weight of the fabric at different stages of processing in the second column. The starting point for the wash trial, aiming to assess fabric shrinkage, was the fabric labelled “Needle punching”. This fabric is listed as medium PB06 in the trial plan (Appendix B). These results suggest that basis weight and fabric thickness are increasing slightly, which is more pronounced after the first wash cycle (commonly attributed to fibre relaxation) but still noticeable for the subsequent 4 wash cycles.

TABLE 2
Fabric properties at different stages of processing:
blend containing chlorine
Hercosett wool cleaned as sliver prior to nonwoven formation

| | Thickness | | Basis Wt. | | Packing | Density |
|---|---|---|---|---|---|---|
| | (mm) | SD | (g/m2) | SD | (%) | SD |
| Nonwoven m'fact. | 4.34 | (0.09) | 249 | (11) | 5.05 | (0.13) |
| Additional cleaning | 4.96 | (0.36) | 224 | (14) | 3.98 | (0.08) |
| Needle punching | 3.49 | (0.19) | 244 | (10) | 6.16 | (0.56) |
| 1 Wash/dry cycle | 4.59 | (0.27) | 251 | (11) | 4.82 | (0.11) |
| 5 Wash/dry cycles | 4.86 | (0.08) | 271 | (5) | 4.91 | (0.03) |

In comparing these results to those from a parallel experiment, where the Cl/Herc wool was processed initially untreated during nonwoven manufacture (i.e. without 5-bowl scouring) but subjected to the same additional wash, needle punching and wash/tumble dry processes as the reference fabric above. Results from this second trial series have been summarised in Table 3 and show no clear trend in changes to basis weight. This may be taken as an indication that changes in basis weight may not be statistically significant and that a larger number of samples would be required to address this (statistics are based on 3 samples from each medium).

TABLE 3
Fabric properties at different stages of processing:
blend containing chlorine
Hercosett wool “as is” on formation of the nonwoven

| | Thickness | | Basis Wt. | | Packing | Density |
|---|---|---|---|---|---|---|
| | (mm) | SD | (g/m2) | SD | (%) | SD |
| Nonwoven m'fact. | 5.06 | (0.15) | 231 | (16) | 4.02 | (0.16) |
| Additional cleaning | 6.08 | (0.38) | 255 | (11) | 3.70 | (0.16) |
| Needle punching | 3.83 | (0.12) | 260 | (25) | 5.98 | (0.52) |
| 1 Wash/dry cycle | 4.04 | (0.18) | 217 | (10) | 4.72 | (0.08) |
| 5 Wash/dry cycles | 4.60 | (0.35) | 249 | (29) | 4.75 | (0.20) |

It is however possible to conclude that basis weight gain as a result of fabric shrinkage is 3% per wash/tumble dry cycle at most, which compares highly favourably to the 40% basis weight gain that was measured for a wool-PP nonwoven where the wool had not been shrink-proofed.

### Example 6

### Assessment of Dimensional Changes

Dimensional changes of the nonwoven fabric were assessed by marking a square of 14.9 cm by 14.9 cm size on the fabric prior to washing and tumble drying, followed by subsequent measurement of distance changes after the treatment.

Measured differences to the original line lengths are listed in Table 4 and differ with orientation to the machine direction. While the fabric was slightly elongated in the cross direction (i.e. perpendicular to the machine direction) it was more distinctly contracted in the main direction (parallel to the fibres), suggesting an overall slight contraction of less than 5% as represented by measurements in the diagonal.

TABLE 4
Dimensional changes as determined after 1 or 5 of 2A wash/dry cycles. Results
show deviations from initial distance in Machine Direction (MD, 149 mm), Cross
Direction (CD, 149 mm) and diagonally (Diag, 210.7 mm).

| | | | CD | | | | MD | | | | Diag | |
|---|---|---|---|---|---|---|---|---|---|---|---|---|
| | CD1 | CD2 | avg | | MD1 | MD2 | avg | | Diag(1) | Diag(2) | avg | |
| | mm | mm | mm | % | mm | mm | mm | % | mm | mm | mm | % |
| 1 Wash/Dry | 2 | 11 | 6.5 | 4.4 | −12 | −19 | −15.5 | 10.4 | −12.7 | −1.7 | −7.2 | 3.4 |
| Cycle | | | | | | | | | | | | |
| 5 Wash/Dry | 9 | 0 | 4.0 | 2.7 | −15 | −22 | −19.3 | 12.9 | −0.7 | −14.7 | −8.9 | 4.2 |
| Cycles (1) | | | | | | | | | | | | |
| 5 Wash/Dry | −3 | 10 | | | −15 | −25 | | | −4.7 | −15.7 | | |
| Cycles (2) | | | | | | | | | | | | |

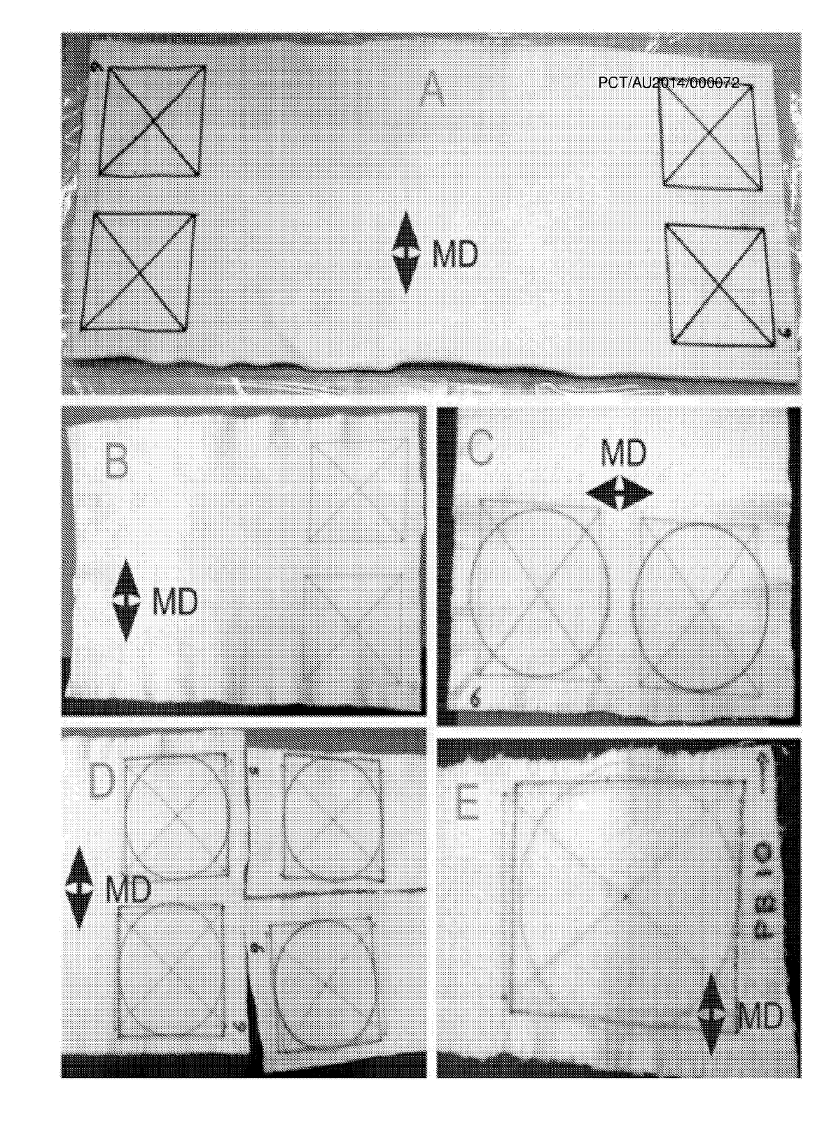

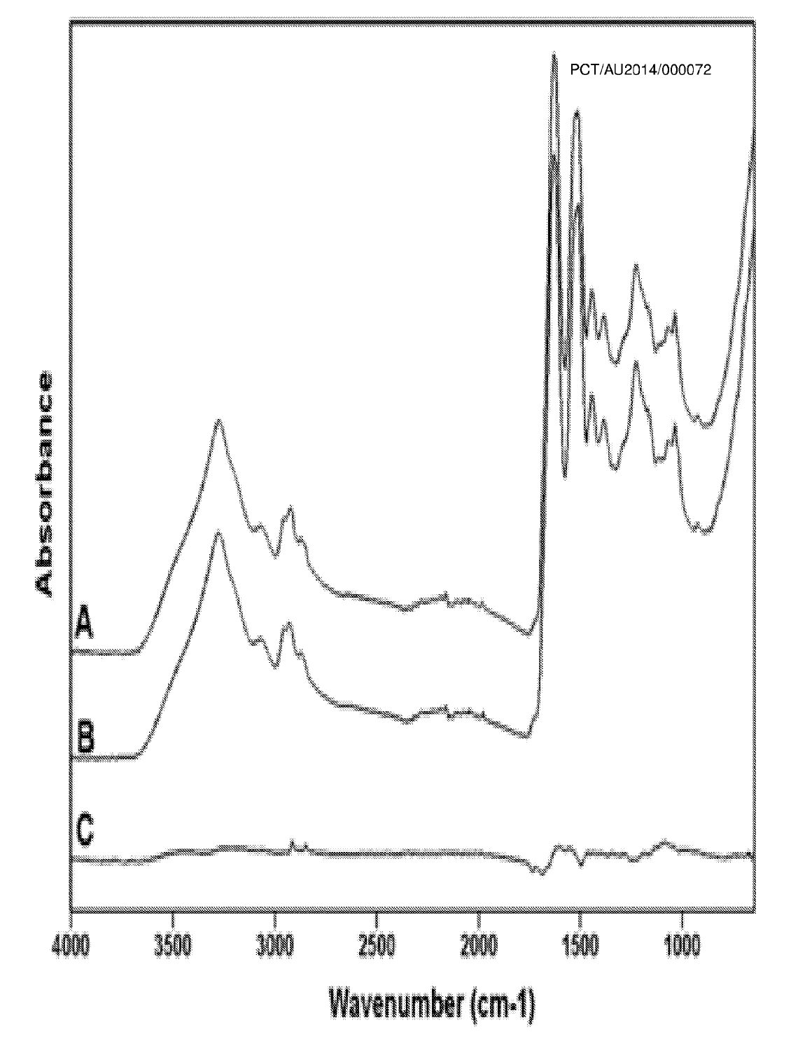

These values represent visible dimension changes that are further illustrated by the photographs of FIG. 1, which show the fabrics at different stages of the Wash Trial. The noticeable contraction in main direction is likely to be indicative of fibre shrinkage because the nonwoven fabric is expected to have a fairly high mechanical strength in this direction. The slight elongation in cross direction could be due to a weakened mechanical strength as a result of fibre orientation by the card. This may place the real value of fabric shrinkage slightly higher than 5%.

Circles were drawn after one or five Wash/Dry Cycles had been completed with centres aligned to that of the original squares. These markings indicate asymmetry, if any, in the fabric deformation.

### Example 7

### Residue Analysis on Wool Fibres

Through infrared spectroscopic analysis attempt to assess if any processing residues are present on two wools.
SW7278 Chlorine Hercosett 21 μm “as is” and
SW7278 washed using hot water in 5 stages (with 5 g/L Alcopol 650 in the first bowl).

Each wool sample was analysed twice using Attenuated Total Reflectance (ATR) infrared spectroscopy. The spectra of the residues transferred to the ATR crystal were also obtained.

Samples of the two wools (0.3 g each) were washed with 5 mL of dichloromethane (DCM) at room temperature. The fibres were removed and the solvent was allowed to evaporate.

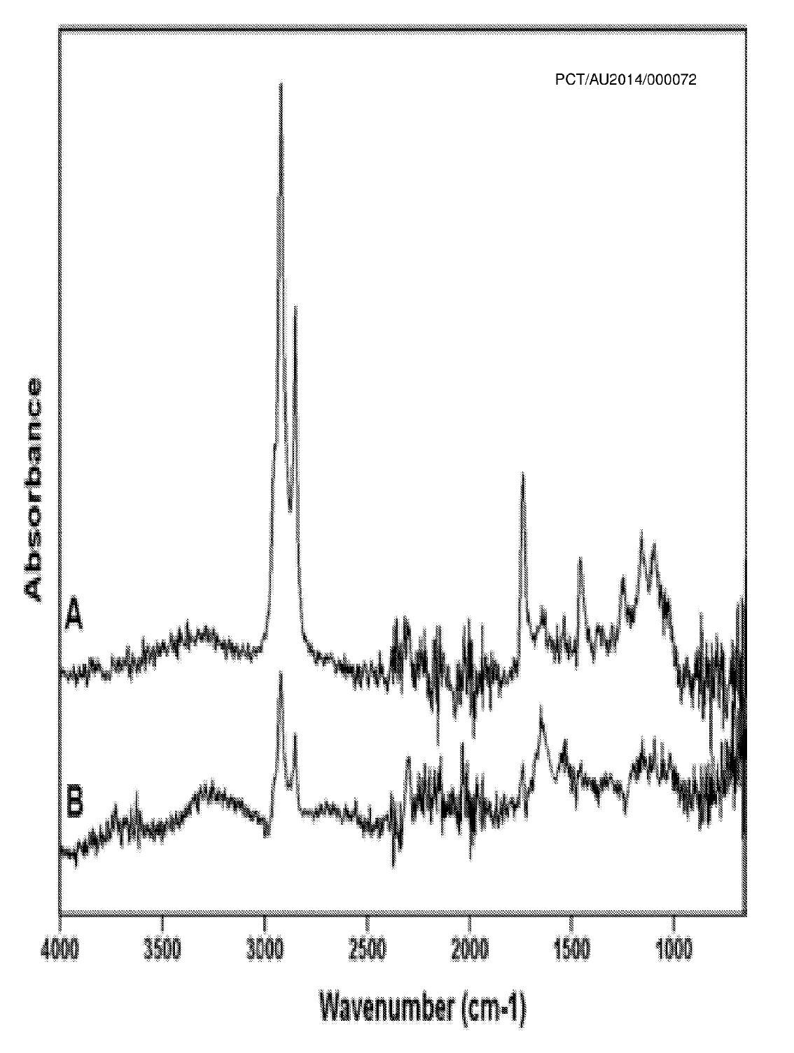

Typical infrared spectra obtained from the “as is” (A) and scoured (B) wool are shown in FIG. 2. There are minor differences that are highlighted by the subtraction shown as (C).

The subtraction suggests that the scouring process has resulted in the removal of aliphatic (CH₂)ₙ and ether or alkoxy (C—O—C) based components (positive peaks) and the deposition of ester (COOR) components (negative peaks). There are also negative spectral peaks in the amide region.

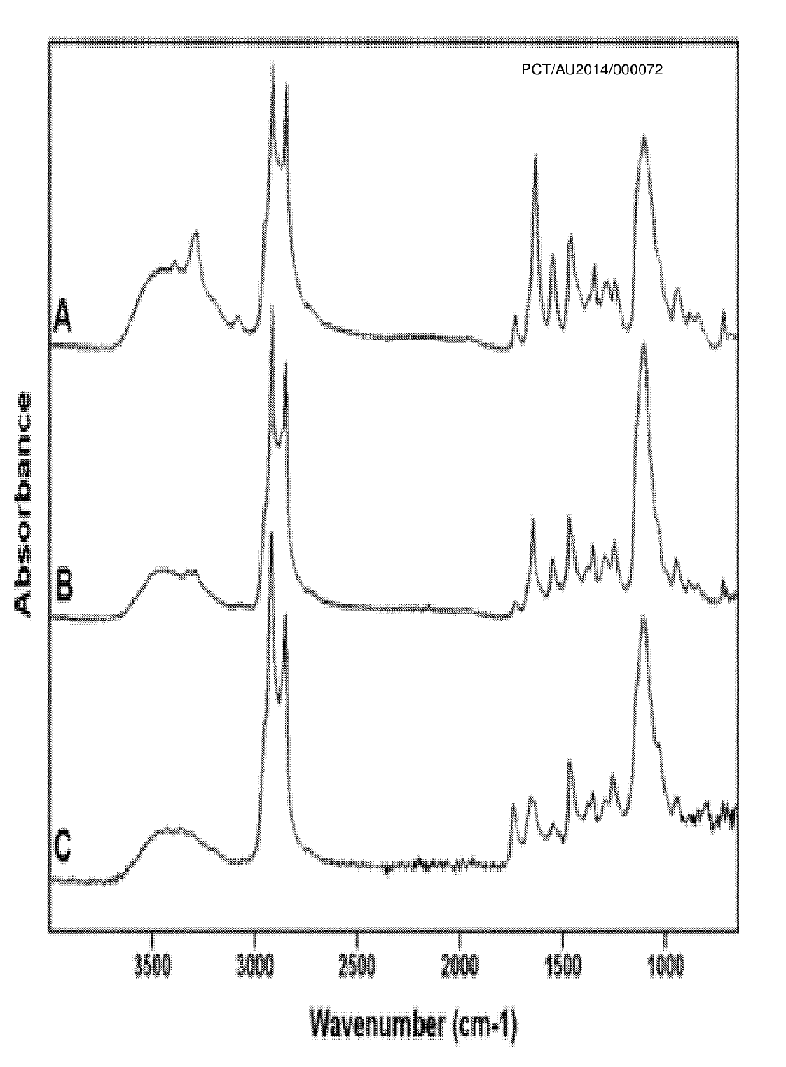

Only very weak spectra were obtained from the residues left on the ATR crystal and their compositions were found to be quite variable when comparing the two spectra obtained from the same wool. These results suggest that the amount of residue on the two wools is quite low and that its composition is complex and its distribution is not very uniform. Typical spectra are shown in FIG. 3

Spectra similar to trace B were observed for both the “as is” and scoured wool while spectra similar to trace A was obtained only from the scoured wool.

Trace (A) can be identified a spectrum of a fatty acid ester with an ether or alkoxy component and is typical of wool lubricants. A minor amount of an amide, possibly a fatty acid amide softening/wetting agent, is also present. Trace B appears to be largely a fatty acid amide with a minor amount of an ester present.

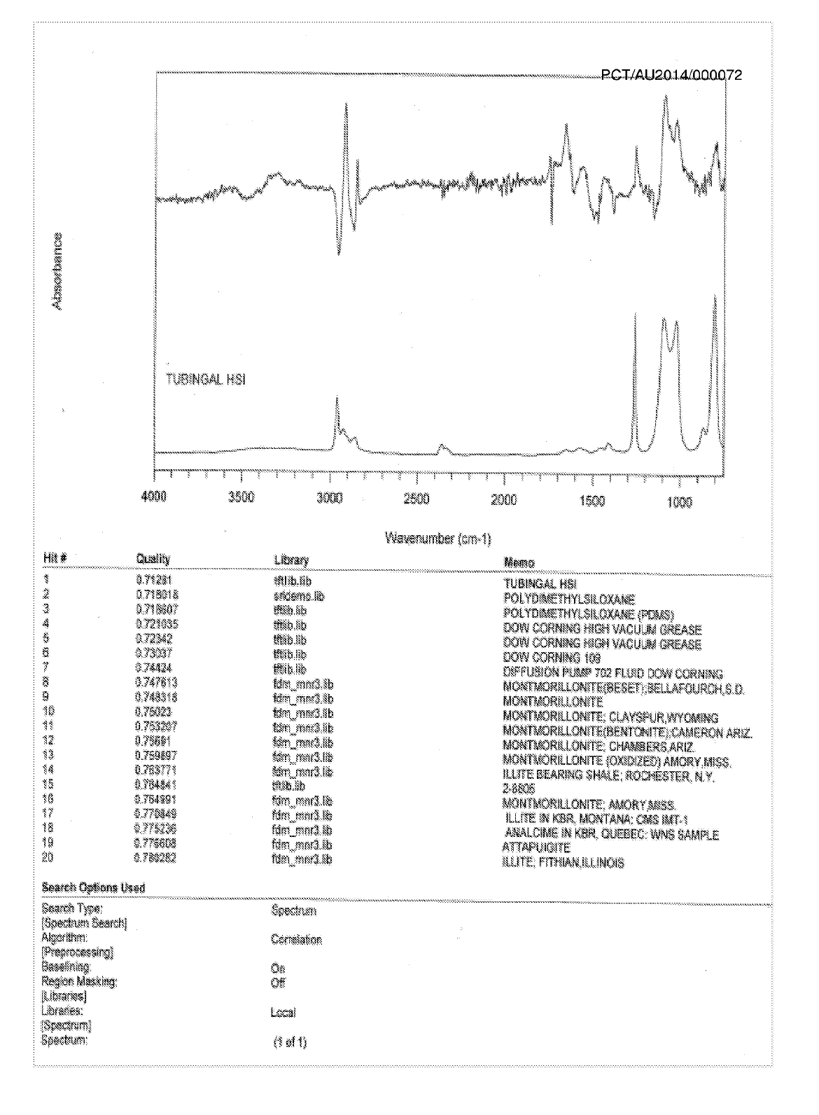

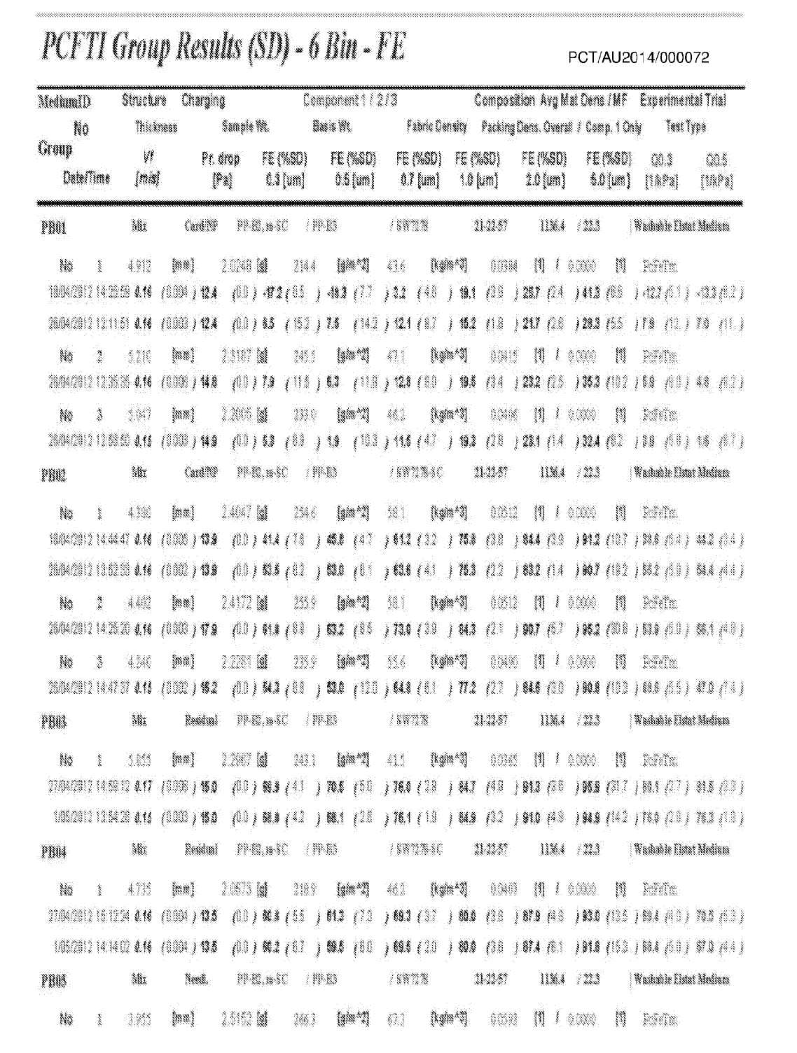

Due to the low level and variability of the residue detected on the ATR crystal, samples of the two wools were washed with dichloromethane (DCM) at room temperature. In both cases, white opaque residues were observed after evaporation of the solvent. The “as is” wool appeared to leave the largest amount of residue. No residue was observed for the DCM blank. The spectra obtained from the residues isolated from the “as is” (A) and scoured (C) wool are shown in FIG. 4

From comparison, the spectrum obtained from the residue isolated from the “as is” wool (A) can be seen to be very similar to that of the polyoxyethylene (POE) saturated fatty amide shown as trace (B). Clearly the ratio of POE to fatty amide is different in these two spectra. The spectrum obtained from the residue isolated from the scoured wool (C) is quite similar; also being a POE based material. There is however clear differences in the amounts of aliphatic branching, the relative concentration of ester and the structure of the amide groups present.

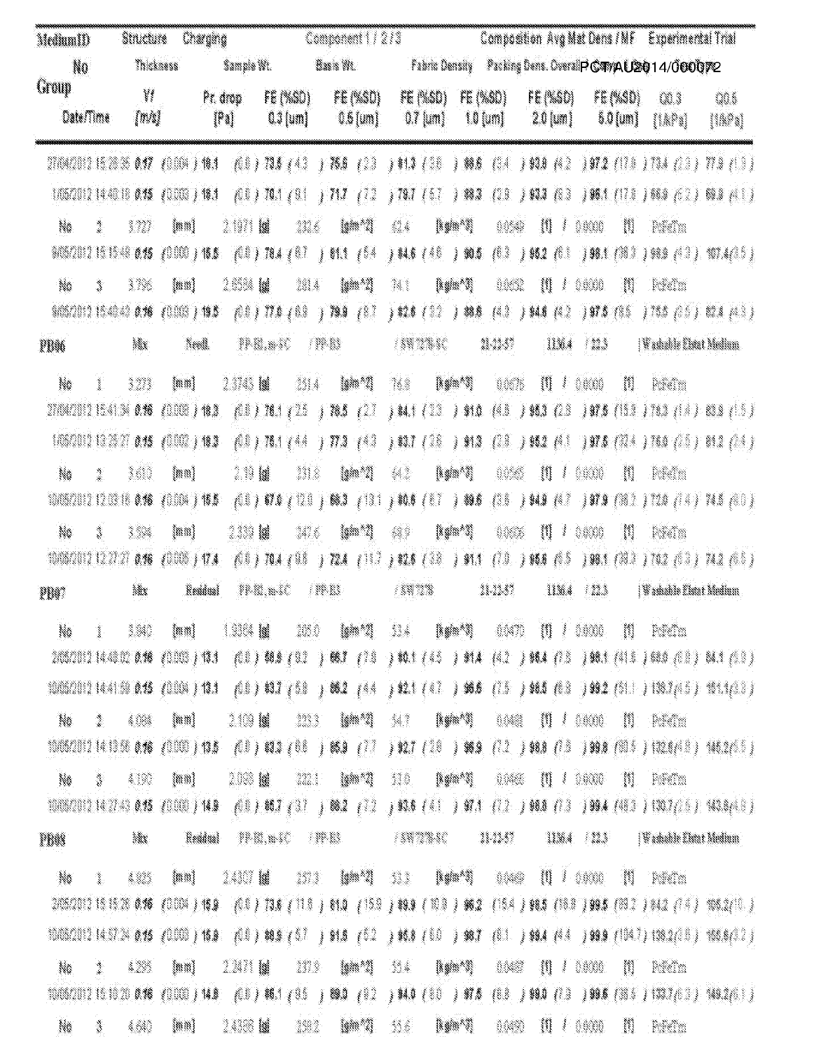

The complexity of the spectra obtained from the isolated residues was investigated through spectral subtraction. Once the spectra of Alcopol 650, wool and a fatty acid ester were subtracted from the spectrum obtained from the scoured wool, a silicone residue was identified (FIG. 5)

No evidence of silicone was detected when a similar process was carried out for the spectrum obtained from the residue isolated from the “as is” wool.

The scouring process appears to be removing a significant amount of the residues present on the “as is” wool which can be identified largely as a mix of POE and fatty amides. These data provide evidence that the scoured wool has picked up some ester and a silicone in the process

Finally, it is to be understood that the inventive concept in any of its aspects can be incorporated in many different constructions so that the generality of the preceding description is not to be superseded by the particularity of the attached drawings. Various alterations, modifications and/or additions may be incorporated into the various constructions and arrangements of parts without departing from the spirit or ambit of the invention.

1. A particulate filtration medium comprising a combination of a wool fiber obtained from an animal, and a synthetic polymeric fiber, the wool fiber being coated with a water soluble resin, wherein the medium is capable of reclaiming electrostatic charge after a washing and/or drying procedure.

2. The particulate filtration medium of claim 1 wherein the water soluble resin forms a substantially continuous coating on the wool fiber.

3. The particulate filtration medium of claim 1 wherein the water soluble resin is not a brittle or frangbile resin.

4. The particulate filtration medium of claim 1 wherein the water soluble resin is not a natural resin.

5. The particulate filtration medium of claim 1 wherein the resin is a resin capable of conferring shrink resistance on the wool fiber.

6. The particulate filtration medium of claim 1, wherein the water soluble resin comprises a polyamide.

7. The particulate filtration medium of claim 1, wherein the water soluble resin comprises a polyamide-epichlorohydrin resin.

8. The particulate filtration medium of claim 1, wherein the water soluble resin comprises a cationic polyamide-epichlorohydrin resin.

9. The particulate filtration medium of claim 1 wherein the water soluble resin comprises Herocosett 125 or Hercosett 57.

10. The particulate filtration medium of claim 1, wherein prior to the application of the resin, the wool fiber is treated to increase the surface energy of the cuticle.

11. The particulate filter of claim 1, wherein prior to the application of the resin the wool fiber is contacted with an oxidant.

12. The particulate filtration medium of claim 11, wherein the oxidant is chlorine.

13. The particulate filtration medium of claim 1, wherein the animal is of the Caprinae family.

14. The particulate filtration medium of claim 13, wherein the animal is of the Ovis genus.

15. The particulate filtration medium of claim 1, wherein the washing and/or drying procedure is a domestic laundering procedure, optionally followed by a domestic tumble drying procedure.

16. The particulate filtration medium of claim 1, wherein the synthetic polymeric fiber is a polyolefin.

17. The particulate filtration medium of claim 16, wherein the polyolefin is polypropylene.

18. The particulate filtration medium of claim 1, wherein the medium is a nonwoven medium.

19. The particulate filtration medium of claim 1, wherein the washing and/or drying process is a domestic washing and/or drying process.

20. A method for producing a particulate filtration medium the method comprising the steps of providing a wool fiber having a characteristic as described in claim 1, combining the wool with a polymer fiber, and optionally forming the combined fibers into a felt.

21. The method claim 20, wherein before use, the felt is washed a first time and dried, and optionally washed a second time and dried such that any softener present on the fiber is removed.

22. The method of claim 20 wherein the felt is needled.

23. A method for fabricating a particulate filter, the method comprising the steps of providing a particulate filtration medium according to claim 1, and packing the medium into a filter housing.

24. The method of claim 23, wherein the filter housing is, or is part of a mask suitable for locating over the mouth and/or nose.

25. The method according of claim 24 wherein the mask is incorporated into or associated with a garment.
